(19) United States
(12) Patent Application Publication
(10) Pub. No.: US 2012/0211932 A1
(43) Pub. Date: Aug. 23, 2012

(54) SPRING CLAMP

(76) Inventor: Ferng Jong LIOU, Taichung (TW)

(21) Appl. No.: 13/323,847

(22) Filed: Dec. 13, 2011

(30) Foreign Application Priority Data
Feb. 23, 2011 (TW) 100203222

(51) Int. Cl. B25B 5/16

(52) U.S. Cl. 269/90

(57) ABSTRACT

A spring clamp includes a pair of jaws and a pair of handles, and is provided at a rear end of each jaw and a front end of each corresponding handle with a rotatable joint mechanism. With the rotatable joint mechanisms, the jaws can be pivotally turned to different angular positions relative to the handles, so as to adjust a clamping angle contained between the two jaws of the spring clamp, enabling the spring clamp to be more convenient for use.

### FIELD OF THE INVENTION

The present invention relates to a spring clamp, which utilizes the technical principle of meshing teeth with a ratchet wheel to form a rotatable joint mechanism at a rear end of each of two jaws and a front end of each of two handles, so that a clamping angle contained between two jaws of the spring clamp is no longer fixed but is adjustable.

### BACKGROUND OF THE INVENTION

A spring clamp is mainly used to clamp two workpieces together to facilitate subsequent machining of the workpieces. For instance, two wood boards can be tightly clamped between two jaws of the spring clamp, so that they can be conveniently drilled or cut. Since most of the currently available spring clamps have two fixed jaws, two or more spring clamps providing different clamping angles are needed to clamp two workpieces having different overall dimensions and thickness. The increased number of spring clamps would increase the manufacturing cost, occupy a large storage space, and bring inconvenience in transporting them.

### SUMMARY OF THE INVENTION

A primary object of the present invention is to provide a spring clamp having adjustable clamping angle to overcome the drawbacks in the prior art spring clamp and make the spring clamp more convenient for use.

To achieve the above and other objects, the spring clamp according to the present invention includes a first circular disc and a second circular disc provided on a rear end of each of the jaws and a front end of each of the handles, respectively, to together form a rotatable joint mechanism. The first and the second circular disc respectively have a first and a second centered through hole, through which a screw bolt is extended. The first circular disc is provided on around a bottom surface with a plurality of continuously arranged teeth (or projected teeth). The second circular disc is similar to the first circular disc in dimensions, shapes and thickness, and is provided on a top surface with a seat having the second through hole centered thereat. The screw bolt extended through the second and the first through hole is meshed with an internally threaded hole on a turning lever. And, the second circular disc is provided on around the top surface with a ratchet wheel (or a plurality of continuously arranged recessed teeth). A compression spring is mounted around the seat on the second circular disc, so that the screw bolt also extends through the compression spring. Further, the first circular disc is provided on a top surface with two circumferentially spaced slope rails, each of which has a lower front end and a higher rear end. The turning lever meshed with the screw bolt can be turned for two opposite ends of the turning lever to move from the lower front ends to the higher rear ends of the two slope rails and tightly press against the slope rails, so that the first circular disc and the second circular disc are immovably held to each other with the projected teeth meshed with the ratchet wheel. When the turning lever is turned for the two opposite ends thereof to press against the lower front ends of the slope rails, the compression spring elastically pushes the first and the second circular disc away from each other to disengage the projected teeth from the ratchet wheel, allowing the jaw to be quickly adjusted to different angular positions relative to the handle to change the clamping angle contained between the jaws of the spring clamp. With these arrangements, the spring clamp of the present invention is more convenient for use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an assembled plan view of a spring clamp according to a preferred embodiment of the present invention;

FIG. 2 is a fragmentary, exploded perspective view of the spring clamp of the present invention shown in FIG. 1;

FIG. 3 is an assembled view of FIG. 2;

FIG. 4 is a fragmentary, assembled perspective view of the spring clamp of the present invention, showing the jaw of the spring clamp is adjusted to an inner angular position relative to a handle;

FIG. 5 is a fragmentary assembled perspective view of the spring clamp of the present invention, showing the jaw of the spring clamp is adjusted to an outer angular position relative to a handle;

FIG. 6 is an assembled plan view of the spring clamp of the present invention, showing two jaws of the spring clamp are adjusted to contain a smaller clamping angle therebetween;

FIG. 7 is an assembled plan view of the spring clamp of the present invention, showing two jaws of the spring clamp are adjusted to contain a larger clamping angle therebetween;

FIG. 8 is a plan view showing a turning lever of the spring clamp of the present invention is turned to allow loosening of the jaw from the handle of the spring clamp; and

FIG. 9 is a plan view showing a turning lever of the spring clamp of the present invention is turned to allow tightening of the jaw against the handle of the spring clamp.

### DETAILED DESCRIPTION OF THE PREFERRED EMBODIMENTS

The present invention will now be described with a preferred embodiment thereof and with reference to the accompanying drawings.

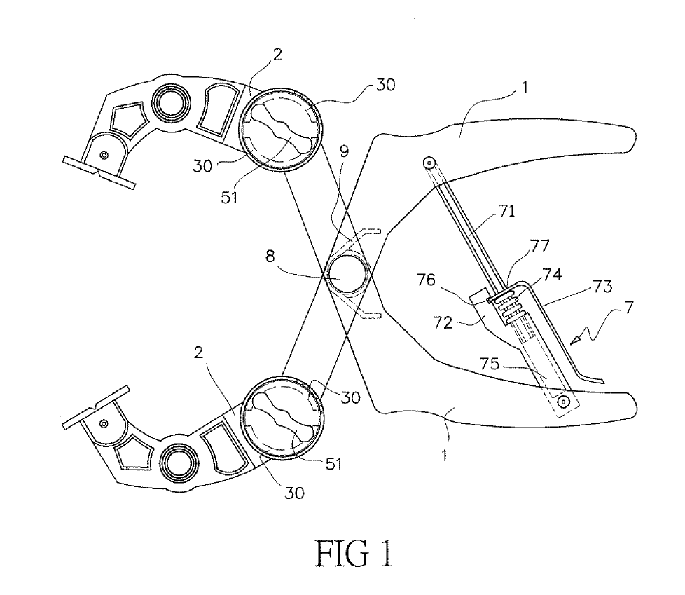

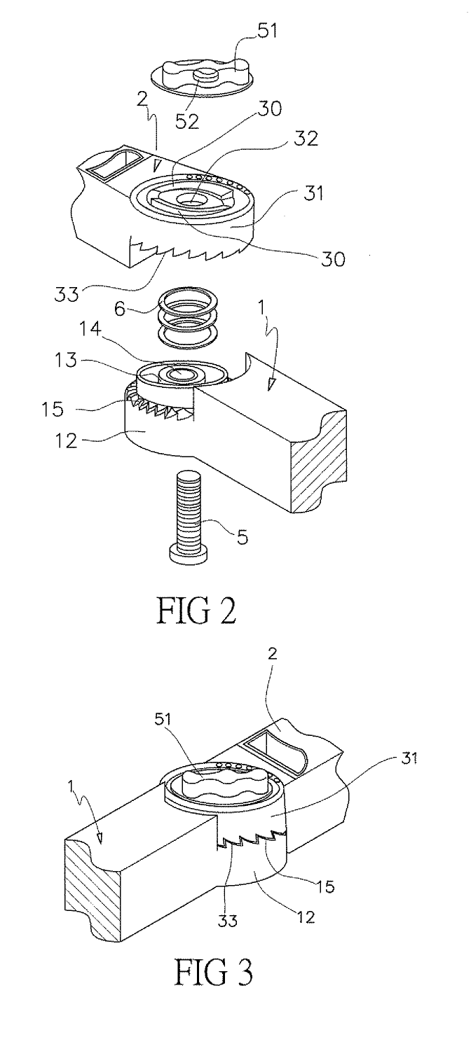

Please refer to FIG. 1 that is an assembled plan view of a spring clamp according to a preferred embodiment of the present invention, and to FIGS. 2 and 3 that are fragmentary exploded and assembled perspective views, respectively, of the spring clamp of FIG. 1. As shown, the spring clamp includes a pair of handles 1, a pair of jaws 2, and a handle locking mechanism 7.

The two handles 1 intersect at respective neck portions and a pivot 8 is provided at the intersection. A torsion spring 9 is provided between the pivot 8 and the two handles 1.

The handle locking mechanism 7 includes a shaft 71, a base 72, a control lever 73, and a compression spring 74. The shaft 71 has an upper end locked to one face of one of the two handles 1 and a lower end inserted in an internal bore 75 formed on the base 72. The base 72 has a bottom locked to one face of the other handle 1. The control lever 73 has a front end pressed against a recess 76 formed near an upper portion of the base 72. The compression spring 74 is mounted on the shaft 71 between the control lever 73 and a neck portion of the base 72. The control lever 73 is provided on a top surface with an opening 77. The two handles 1 can be controlled to a locked position relative to each other by pressing the opening 77 against an outer surface of the shaft 71. Since the technique of controlling the two handles 1 to a locked position via the control lever 73 is not a feature to be claimed in the present invention, it is not discussed in details herein.

The spring clamp according to the present invention is characterized in two rotatable joint mechanisms respectively provided on a rear end of one jaw 2 and a front end of one handle 1. Since the two rotatable joint mechanisms are identical, the following description of the present invention is made based on one single rotatable joint mechanism.

As can be most clearly seen in FIG. 2, a first circular disc 31 is provided on the rear end of the jaw 2, and the first circular disc 31 is provided at a central area with a first through hole 32, through which a screw bolt 5 can be extended. The first circular disc 31 is also provided on around a bottom surface with a plurality of continuously arranged teeth 33 (or projected teeth). On the other hand, a second circular disc 12 is provided on a front end of the handle 1 in front of the neck portion of the handle 1. The second circular disc 12 is similar to the first circular disc 31 in dimensions, shape and thickness, and is provided at a central area with a seat 13 having a centered second through hole 14, via which the screw bolt 5 can be extended through the first through hole 32 on the first circular disc 31 to mesh with an internally threaded hole 52 on a turning lever 51. The second circular disc 12 is also provided on around a top surface with a ratchet wheel 15 (or a plurality of continuously arranged recessed teeth). By mounting a compression spring 6 around the seat 13, sequentially extending the screw bolt 5 through the second and first through holes 14, 32, and meshing the screw bolt 5 with the threaded hole 52 of the turning lever 51, the first circular disc 31 and the second circular disc 12 on the corresponding jaw 2 and handle 1 can be axially complementarily aligned and engaged with each other to form a rotatable joint mechanism.

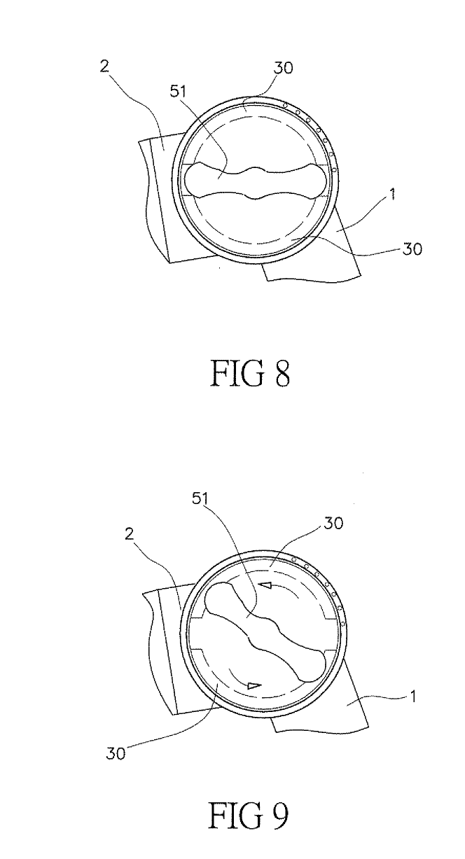

Further, the first circular disc 31 is provided on a top surface with two circumferentially spaced slope rails 30, which respectively have a lower front end and higher rear end. The turning lever 51 meshed with the screw bolt 5 can be turned for two opposite ends thereof to move from the lower front ends to the higher rear ends of the two slope rails 30, or from the higher rear ends to the lower front ends of the two slope rails 30. When the turning lever 51 is turned for the two opposite ends to press against the lower front ends of the two slope rails 30, as shown in FIG. 8, a spring force of the compression spring 6 would axially move the first and the second circular disc 31, 12 outward to thereby disengage the teeth 33 on the first circular disc 31 from the ratchet wheel 15 on the second circular disc 12, allowing the jaw 2 to be turned relative to the handle 1. On the other hand, when the turning lever 51 is turned for the two opposite ends thereof to press against the higher rear ends of the two slope rails 30, as shown in FIG. 9, the compression spring 6 is compressed, and the first and the second circular disc 31, 12 are tightly held to each other, preventing the jaw 2 from being turned relative to the handle 1. With these arrangements, the movement of the rotatable joint mechanism can be controlled via the tightness of connection between the first and the second circular disc 31, 12, and a clamping angle contained between the two jaws 2 of the spring clamp can be quickly adjusted to be larger or smaller.

Please refer to FIGS. 2 and 3. To assemble the rotatable joint mechanism of the spring clamp according to the present invention, first mount the compression spring 6 around the seat 13, and then align the first through hole 32 on the first circular disc 31 with the centered second through hole 14 on the second circular disc 12, and finally screw the screw bolt 5 through the aligned first and second through holes 32, 14 into the threaded hole 52 of the turning lever 51. At this point, the teeth 33 (or projected teeth) on around the bottom surface of the first circular disc 31 mesh with the ratchet wheel 15 (or recesses teeth) on around the top surface of the second circular disc 12 to together constitute a rotatable joint mechanism.

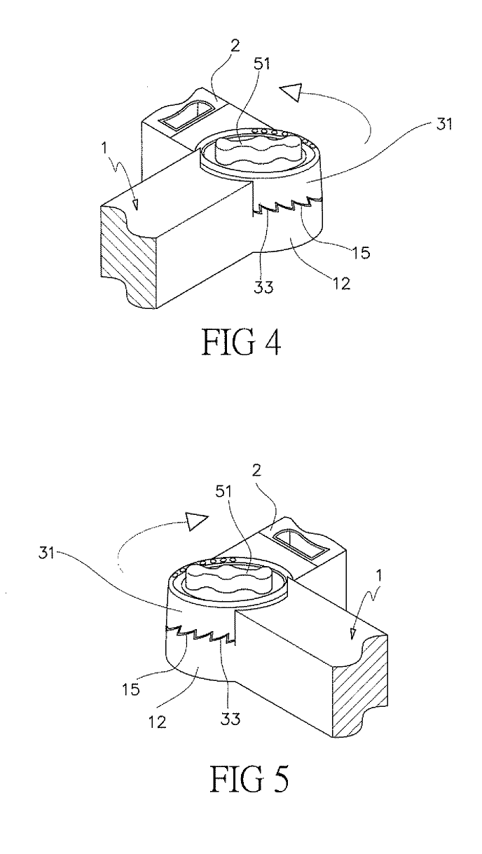

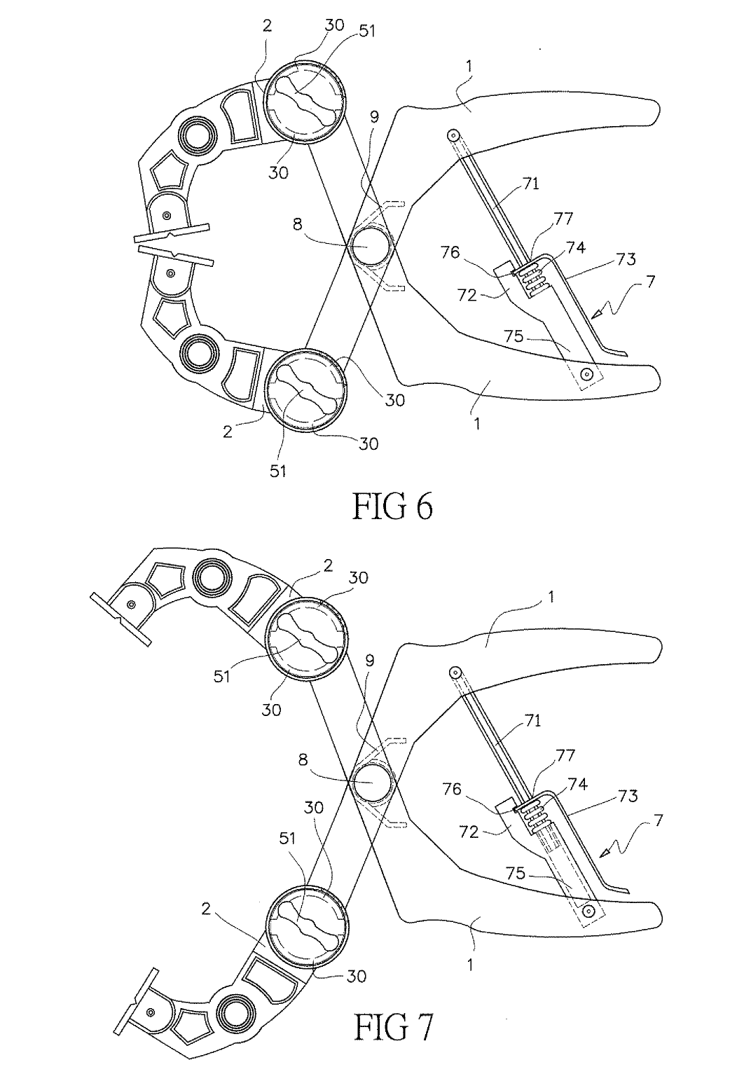

Please refer to FIGS. 4, 5, 6 and 7. When it is desired to adjust a clamping angle contained between the two jaws 2 of the spring clamp, simply turn the turning lever 51 for the two opposite ends thereof to press against the lower front ends of the two slope rails 30, allowing the compression spring 6 to elastically push the first and second circular discs 31, 12 away from each other and accordingly disengage the teeth 33 (or the projected teeth) on the bottom surface of the first circular disc 31 from the ratchet wheel 15 (or the recessed teeth) on the top surface of the second circular disc 12. At this point, the jaw 2 of the spring clamp can be turned relative to the corresponding handle 1 to an outer angular position, as shown in FIGS. 5 and 7, or to an inner angular position, as shown in FIGS. 4 and 6, so that the clamping angle contained between the jaws of the spring clamp is adjusted to be larger or smaller. After the clamping angle has been adjusted, the turning lever 51 is turned again for the two opposite ends thereof to press against the higher rear ends of the slope rails 30, so that the compression spring 6 is compressed again and the first circular disc 31 is tightly held to the second circular disc 12 with the teeth 33 (or the projected teeth) meshed with the ratchet wheel 15 (or the recessed teeth), enabling the jaw 2 to be quickly and conveniently locked to the adjusted position.

Compared to the conventional spring clamp, the spring clamp with the above arrangements according to the present invention is largely improved in terms of its operation, use and performance.

What is claimed is:

1. A spring clamp comprising a pair of handles, a pair of jaws, and a handle locking mechanism; the handle locking mechanism including a shaft, a base, a control lever, and a compression spring; the shaft having an upper end locked to one face of one of the two handles, and a lower end inserted in an internal bore formed on the base; the base having a bottom locked to one face of the other handle; the control lever having a front end pressed against a recess formed near an upper portion of the base; the compression spring being mounted on the shaft between the control lever and a neck portion of the base; the control lever being provided on a top surface with an opening, and the two handles being controllable to a locked position relative to each other by pressing the opening against an outer surface of the shaft;
characterized in that
a first circular disc being provided on a rear end of each of the jaws and having a centered first through hole, through which a screw bolt is extended; and the first circular disc being provided on around a bottom surface with a plurality of continuously arranged projected teeth; and
a second circular disc being provided on a front end of each of the handles, and being similar to the first circular disc in dimensions, shape and thickness; the second circular disc being provided on a top surface at a central area with a seat having a centered second through hole, via which the screw bolt is extended through the first through hole on the first circular disc to mesh with an internally threaded hole formed on a turning lever; and the second circular disc being provided on around the top surface with a ratchet wheel including a plurality of continuously arranged recessed teeth;
whereby by mounting a compression spring around the seat, sequentially extending the screw bolt through the second and first through holes, and meshing the screw bolt with the threaded hole of the turning lever, the first circular disc and the second circular disc on the corresponding jaw and handle, respectively, are axially complementarily aligned and engaged with each other to form a rotatable joint mechanism.

2. The spring clamp as claimed in claim 1, wherein the first circular disc is provided on a top surface with two circumferentially spaced slope rails, each of which has a lower front end and a higher rear end.

3. The spring clamp as claimed in claim 2, wherein the turning lever meshed with the screw bolt is turnable for two opposite ends of the turning lever to press against the lower front ends or the higher rear ends of the two slope rails on the first circular disc.
